(19) United States
(12) Patent Application Publication
(10) Pub. No.: US 2021/0116253 A1
(43) Pub. Date: Apr. 22, 2021

(54) METHOD FOR CONTROL OF AN AUTONOMOUS VEHICLE WITH INTERNAL DELAYS

(71) Applicant: ELTA SYSTEMS LTD, Ashdod (IL)

(72) Inventors: Ofir Cohen, Tzelafon (IL); Dina Appleman, Bat-Yam (IL)

(21) Appl. No.: 17/051,839

(22) PCT Filed: May 6, 2019
(86) PCT No.: PCT/IL2019/050506

§ 371 Date: Oct. 30, 2020

(30) Foreign Application Priority Data
May 10, 2018 (IL) 259292

(51) Int. Cl. G01C 21/34; G05D 1/02

(52) U.S. Cl. CPC G01C 21/3415; G05D 1/027; G05D 1/0274; G05D 1/0214

(57) ABSTRACT

A method, an unmanned ground vehicle (UGV), a system mountable on a UGV and a computer program product, the method comprising: receiving an indication for generating a new navigation command; estimating, by the processor, an expected state of the UGV when the new navigation command is to be executed, based on accumulated effects of pending commands; generating, by the processor, the new navigation command based on the expected state; and following execution of pending commands, executing the new navigation command, thereby steering the UGV.

### TECHNICAL FIELD

The presently disclosed subject matter relates to autonomous navigation in general, and more particularly to navigating an unmanned vehicle.

### BACKGROUND

An unmanned ground vehicle (UGV), also referred to as an uncrewed vehicle, is a motorized machine that travels by integrating sensory data with computer-based decision-making, for the purpose of autonomously driving the vehicle.

One issue related to UGV operation is autonomous navigation that includes planning a path and following it. When navigating the vehicle, information with respect to obstacles which are located within the traversed area is used for determining a route that avoids the obstacles to enable the vehicle to safely travel through the area. An obstacle can be any area or object which should be avoided. For example, an obstacle can be an object or area which either blocks or endangers the vehicle, e.g. slopes, holes in the ground, water reservoirs, walls, big rocks, overhead obstacles e.g., bridges, etc. Obstacles can also be any area which is desired to be avoided (e.g. noxious areas, habitat areas which should be avoided for ecological or animal conservation reasons, populated areas which should be avoided for safety reasons, etc.). A path to a destination is normally planned while striving to avoid collision with obstacles, and avoiding getting too close to obstacles, if possible. Path planning also strives to comply with other requirements, for example efficiency, e.g., avoiding paths which are unnecessarily elongated or winding. Once a path is planned or updated, it is followed by generating and executing steering commands directed for controlling the UGV along the path.

### GENERAL DESCRIPTION

The disclosure relates to navigating a UGV within an area in the presence of obstacles. Navigation can include generating a representation of the area, such as a map or any other internal data structure, the representation comprising indications of the obstacles and a destination of the navigation. The map can then be used for planning a path which leads to the destination while avoiding obstacles. During navigation, steering commands can be provided to the UGV for following the path.

However, a delay (referred to herein as “command execution delay”) is known to exist between the time at which a steering command is received by the control systems of the UGV, and the time at which the command is executed. For example, in some cases a delay between 200 milliseconds (msec) and 750 msec is observed. Command execution delay may result, for example, from mechanical latencies and/or processing latencies in different assemblies of the UGV, such as the internal communication system or other electrical or electronic assemblies. Thus, generating a steering command based on a current location of the UGV while ignoring the expected delay may lead to undesired results, such as collision with obstacles or deviations from a designated path. This is so, since the UGV continues to move during the time period of the delay, from its current location according to its current velocity and acceleration, before the current command is executed.

Additionally, previous commands which will be executed prior to execution of a current (more recent) command, may also change the location and direction of the UGV at the time of execution of the current command. For example, a new command may be issued every time data indicating that a trigger event has occurred, is received, (e.g. a timer event when a commands execution is coordinated with time). For example, a timer event can be received every 100 msec, while the command execution delay is 500 msec, thus, according to this example, five commands may be executed between the time a command is issued and the time it is executed. Therefore, the change in UGV location, heading and speed during the command execution delay results from the accumulative change caused by all commands which are executed during the time period of the delay. Thus, in order to safely and efficiently guide the UGV, it is required to consider the effect of these commands.

In accordance with some embodiments of the disclosure, prior to generating a navigation command, the future location, orientation and velocity of the UGV at the (predicted) execution time of the navigation command is estimated, such that the command is generated in accordance with the estimated location, orientation and velocity of the UGV at the time of the command execution. Vehicle parameters such as location, orientation and velocity are collectively referred to herein as “state”. This list of parameters is not exhaustive and in some examples it can also include additional parameters such as acceleration, etc. Given a navigation command, in order to estimate the future state of the UGV at the time of its execution, the integrated effect on the UGV state of all pending commands bound to be executed during the command's execution delay, is assessed. Such assessment can be done by processing the commands in the order in which they are received, and, for each command, estimating the effect it will have on the state of the UGV after the previous command has been executed.

Thus, an aspect of the disclosed subject matter relates to a method of navigating an unmanned ground vehicle (UGV), the vehicle comprising a scanning device providing scanning output data and a processor, the method comprising: receiving an indication that trigger event generation for generating a new navigation command has been triggered receiving an indication that generation of a new navigation command has been triggered; estimating, by the processor, an expected state of the UGV when the new navigation command is to be executed, based on accumulated effects of pending commands; generating, by the processor, the new navigation command based on the expected state; and following execution of pending commands, executing the new navigation command, thereby steering the UGV.

In addition to the above features, the method according to this aspect of the presently disclosed subject matter can optionally comprise one or more of features (i) to (ix) listed below, in any technically possible combination or permutation:
i. Wherein estimating the expected state of UGV comprises: while there is at least one pending navigation command which has not been processed since the indication has been received: retrieving, by the processor, an earliest pending navigation command which has not been processed since the indication has been received; and determining, by the processor, an expected effect of the earliest pending navigation command on the state of the UGV to update the expected state of the UGV.
ii. Wherein the expected state of the UGV includes at least a location of the UGV.
iii. The method further comprises steering the UGV in accordance with the new navigation command.
iv. Wherein generating the new navigation command for navigating the UGV comprises planning a path from a current location of the UGV to a destination of the UGV.
v. Wherein the at least one pending navigation command comprises a number of commands, the number determined in accordance with a command providing rate and an expected delay between provisioning and execution times of a command.
vi. The method further comprises comparing a current state of the UGV with a state predicted in association with generating a previous command to obtain comparison results, and adapting the new navigation command in accordance with the comparison results.
vii. Wherein the indication is received responsive to an event selected from the group comprising a timer event or interrupt; detection of an obstacle; and arrival of the UGV to a predetermined location.
viii. Wherein the UGV further comprises an Inertial Navigation System (INS) operatively connected to a processor, the method further comprising: receiving INS data indicative of a location of the UGV relative to a previous location; and using the INS data in determining the state of the UGV to be used in obtaining the expected state of the UGV.
ix. The method further comprises storing an expected state of the UGV after execution of one or more commands; upon execution of the one or more commands, comparing an actual state of the UGV to the expected state of the UGV, respectively to obtain comparison results; and updating the new navigation command based on the comparison results.

According to another aspect of the presently disclosed subject matter there is provided an unmanned ground vehicle (UGV), comprising: a scanning device for scanning an area surrounding the UGV to thereby provide scanning output data providing information about distances between objects in the area and the UGV in a multiplicity of directions; an Inertial Navigation System (INS) for providing kinematic parameters of the UGV at a given time; and a processor configured to: receive an indication that generation of a new navigation command has been triggered; estimate, by the processor, an expected state of the UGV when the new navigation command is to be executed, based on accumulated effects of pending commands; generate, by the processor, the new navigation command based on the expected state; and following execution of pending commands, execute the new navigation command, thereby steering the UGV.

The UGV disclosed in accordance with the aspects of the presently disclosed subject matter detailed above can optionally comprise one or more of features (i) to (ix) listed above, mutatis mutandis, in any technically possible combination or permutation.

According to yet another aspect of the presently disclosed subject matter there is provided a system mountable on an unmanned ground vehicle (UGV), comprising: a processor configured to: receive an indication that generation of a new navigation command has been triggered; estimate, by the processor, an expected state of the UGV when the new navigation command is to be executed, based on accumulated effects of pending commands; generate, by the processor, the new navigation command based on the expected state; and following execution of pending commands, execute the new navigation command, thereby steering the UGV.

The system disclosed in accordance with the aspects of the presently disclosed subject matter detailed above can optionally comprise one or more of features (i) to (ix) listed above, mutatis mutandis, in any technically possible combination or permutation.

According to yet another aspect of the presently disclosed subject matter there is provided a computer program product comprising a computer readable storage medium retaining program instructions, which programs instructions when read by a processor, and causes the processor to perform a method comprising receiving an indication that generation of a new navigation command has been triggered, estimating, by the processor, an expected state of the UGV when the new navigation command is to be executed, based on accumulated effects of pending commands; generating, by the processor, the new navigation command based on the expected state; and following execution of pending commands, executing the new navigation command, thereby steering the UGV.

The computer program product disclosed in accordance with the aspects of the presently disclosed subject matter detailed above can optionally comprise one or more of features (i) to (ix) listed above, mutatis mutandis, in any technically possible combination or permutation.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates a schematic block diagram of a UGV, in accordance with certain examples of the presently disclosed subject matter;

FIG. 2 shows a schematic illustration of an environment in which a UGV has to navigate;

FIG. 3A illustrates a generalized flow-chart of a method for navigating a UGV in the presence of obstacles, in accordance with certain examples of the presently disclosed subject matter;

FIG. 3B illustrates a sequence of commands generated for the UGV, in accordance with certain examples of the presently disclosed subject matter;

FIG. 4A illustrates a visual representation of navigating while ignoring delays;

FIG. 4B illustrates a visual representation of navigating while considering delays but not considering queued commands; and

FIG. 4C illustrates a visual representation of navigating while taking into account delays and queued commands, in accordance with certain examples of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “determining”, “representing”, “comparing”, “generating”, “assessing”, “matching”, “updating”, “creating” or the like, refer to the action(s) and/or process(es) of a computer that manipulate and/or transform data into other data, said data represented as physical, such as electronic, quantities and/or said data representing the physical objects.

The terms “processor”. “computer”, “processing unit” or the like should be expansively construed to include any kind of electronic device with data processing circuitry, which includes a computer processor as disclosed herein below (e.g., a Central Processing Unit (CPU), a microprocessor, an electronic circuit, an Integrated Circuit (IC), firmware written for or ported to a specific processor such as digital signal processor (DSP), a microcontroller, a field programmable gate array (FPGA), an application specific integrated circuit (ASIC), etc.) and possibly a computer memory and is capable of executing various data processing operations.

The operations in accordance with the teachings herein may be performed by a computer device specially constructed for the desired purposes or by a general-purpose computer specially configured for the desired purpose by a computer program stored in a computer readable storage medium.

In the following detailed description, numerous specific details are set forth in order to provide a thorough understanding of the invention. However, it will be understood by those skilled in the art that the presently disclosed subject matter can be practiced without these specific details. In other instances, well-known methods, procedures, components and circuits have not been described in detail so as not to obscure the presently disclosed subject matter.

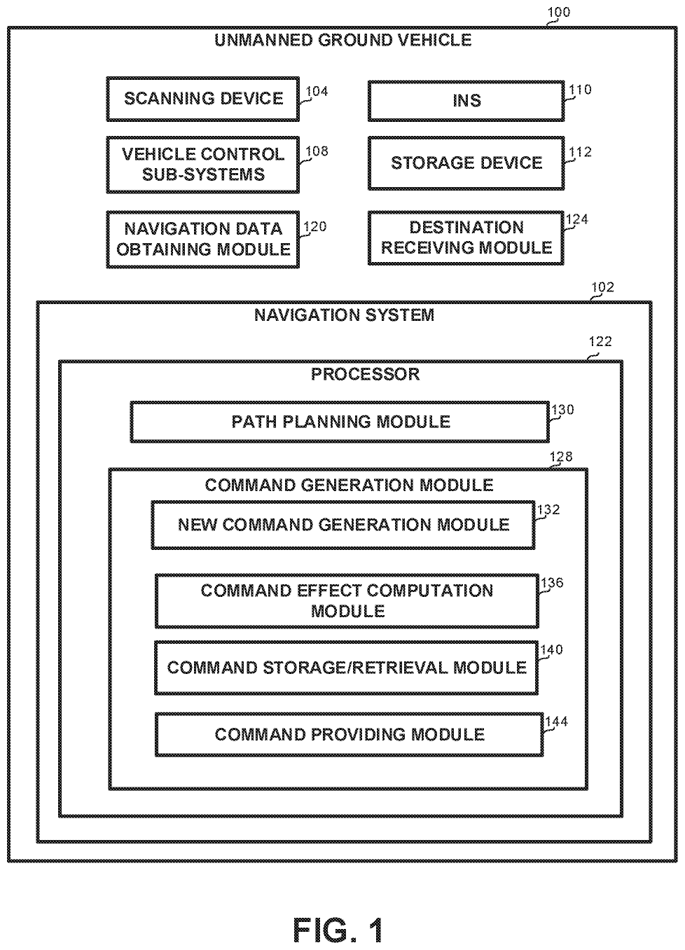

FIG. 1 illustrates a general schematic block diagram of a UGV in accordance with an embodiment of the presently disclosed subject matter. Each module in FIG. 1 can be made up of any combination of software, hardware and/or firmware that performs the functions as defined and explained herein. The modules in FIG. 1 may be centralized in one location or on one device, or dispersed over more than one location or device. In different examples of the presently disclosed subject matter, the system may comprise fewer, more, and/or different modules than those shown in FIG. 1. For example, while processor 122 in FIG. 1 is illustrated within navigation system 102, in other cases processor 122 can be a separate processor dedicated for executing some operations and externally connected to navigation system 102.

As will be further detailed with reference to FIG. 1, processor 122 comprises a processing circuitry which can be configured to execute several functional modules in accordance with computer-readable instructions implemented on a non-transitory computer-readable storage medium. Such functional modules are referred to hereinafter as comprised in the processor and include for example command generation module 128.

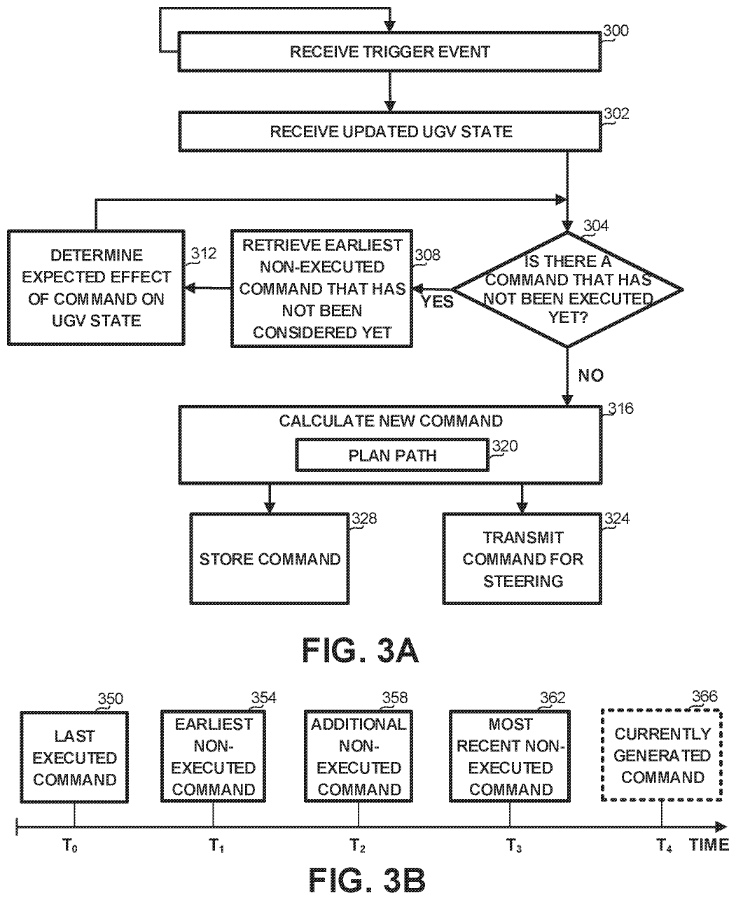

FIG. 3A is a flowchart illustrating operations of respective processes, in accordance with the presently disclosed subject matter. In embodiments of the presently disclosed subject matter, fewer, more and/or different stages than those shown in FIG. 3A may be executed. In embodiments of the presently disclosed subject matter one or more stages illustrated in FIG. 3A may be executed in a different order and/or one or more groups of stages may be executed simultaneously for multiple commands.

A UGV in accordance with the description is equipped with a scanning device configured to scan the area surrounding the UGV, and an INS configured to provide positioning data of the UGV.

The term “scanning device” as used herein should be expansively construed to include any kind of device configured to identify, for objects in the vicinity of the device, their distance and direction relative to the device. Examples of scanning devices include, but are not limited to: laser scanners (including LIDAR), RADAR, images sensor, sonar, etc. A scanning device can scan for example, 360° on a plane surrounding the device, or in some other smaller scanning angle (e.g. 180°). Alternatively, the scanning device can scan a volume such as a sphere, a cylinder or another three dimensional volume or part thereof in the vicinity of the UGV. A scanning device can provide information for generating a 3-dimensional map of the scanned area. In some examples, in order to save resources, a 2.5-dimensional map can be generated, as detailed below.

The term “map” as used herein should be expansively construed to include any data structure representing a geographical area. A map can be absolute, i.e., comprise indications of absolute coordinates of an object or a location, or relative, i.e., comprise information about locations or objects, regardless of their locations in absolute coordinates. A map can be represented on a computerized display device, paper or any other tangible medium.

Reference is now made to FIG. 1, showing a schematic block diagram of a UGV, in accordance with some examples of the disclosure.

UGV 100 can comprise or be otherwise operatively connected to a scanning device 104 configured to scan an area surrounding the vehicle, and provide scanning output data used for generating maps, as further described below.

UGV 100 can further comprise or be otherwise operatively connected to vehicle control sub-systems 108 including for example steering control unit, gear control unit, throttle control unit, etc. Vehicle control sub-systems 108 are configured to receive vehicle control commands (e.g., steering instructions) and control UGV 100 accordingly. Such commands include, by way of example “gas 30%, yaw rate 50%”, “turn right”, “brake”, or the like. It will be appreciated that in order to avoid a situation in which a command has not been completed by the time the next command is to be executed, commands are not defined by their target, such as “go 20 m north”, but rather by the operation to be undertaken, such as “gas 20%”. It will be appreciated that the terms “instruction”, “navigation instruction”. “command” and “navigation command” as used below, are interchangeable.

UGV 100 can further comprise or be otherwise operatively connected to an Inertial Navigation System (INS) 110. An INS calculates the kinematic parameters of the UGV based upon readings received from an Inertial Measurement Unit (IMU). The kinematic parameters of the UGV are tracked relative to the parameters at a starting position, thus providing for assessing the parameters at a given time based on previous values.

UGV 100 can further comprise one or more computer storage devices 112 for storing information such as one or more maps, information on obstacles, navigation commands, or the like.

UGV 100 can comprise by way of example, navigation data obtaining module 120, configured for receiving readings from scanning device 104 and creating or updating one or more maps representing one or more areas in the vicinity of the UGV.

UGV 100 can further comprise destination receiving module 124 for obtaining a destination to which UGV 100 has to arrive. Destination receiving module 124 can comprise or utilize components such as but not limited to: a Global Positioning System (GPS); a communication unit for receiving a location or commands from an external source; a camera and a computerized vision system for capturing images of the environment and identifying in the images a predetermined sign indicating a target destination. The indication can include for example visible or invisible light, a predetermined gesture performed by a person or a machine, or the like.

UGV 100 can comprise navigation system 102. It will be appreciated that navigation system 102 can comprise components, some of which can also serve other purposes, and that components of navigation system 102 can be located at different parts of UGV 100 or, in some examples, be external to it. Further, navigation system 102 can also receive services from and communicate with other components of UGV 100 or external components or systems.

Navigation system 102 can comprise or be otherwise operatively connected to one or more processing units for controlling and executing various operations, as disclosed herein. Each processing unit comprises a respective processing circuitry comprising at least one computer processor which can be, for example, operatively connected to a computer-readable storage device having computer instructions stored thereon to be executed by the computer processor.

According to one example, different functional elements (units, modules) in navigation system 102 can be implemented as a dedicated processing unit comprising a dedicated computer processor and computer storage for executing specific operations.

Additionally or alternatively, one or more functional elements can be operatively connected to a common processing unit configured to execute operations according to instructions stored in the functional elements.

For example, navigation system 102 can comprise one or more processing circuitries (one is illustrated by way of example to include processor 122), which can be configured to execute several functional modules in accordance with computer-readable instructions stored on a non-transitory computer-readable medium (e.g. storage device 112) operatively connected to processor 122. For illustrative purposes, such functional modules are referred to hereinafter as comprised in the processor. By way of example, other modules illustrated outside of processor 122 can be operatively connected and executed by the same processor in the same processing circuitry or by a different processor of a different processing circuitry.

Processor 122 can comprise by way of example path planning module 130 and command generation module 128.

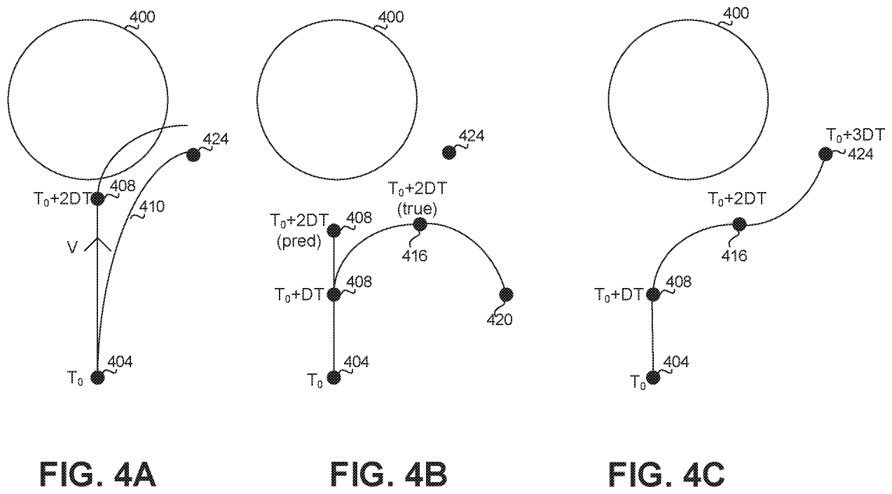

Path planning module 130 can be configured to receive a map of an area around the UGV. The map can be generated, for example, based on scanning output data provided by scanning device 104, and a destination, as obtained for example by destination receiving module 124. Path planning module 130 can then plan a path from a current location of the UGV to the destination. The path should avoid obstacles or other areas which are undesired, and comply with additional limitations such as pitch and roll angles allowed for the UGV, or the like. The path can be planned, for example, as described in Israeli Patent Application no 253769 filed Jul. 31, 2017, and particularly as explained in FIG. 3 and exemplified in FIG. 4 and the associated description: page 16 line 18 to page 23 line 25 of said application.

Command generation module 128 can comprise new command generation module 132, for generating a new navigation command for navigating the UGV. A navigation command is generated in order to direct the UGV in a desired direction and speed (e.g. based on a predefined progression path) and is based on the expected or predicted state of the UGV following the command execution delay, i.e., at the time the command is executed. Thus, the command generation module uses the predicted state of the UGV after all outstanding navigation commands are executed when calculating the next command that will advance the UGV along the path. If required, for example if the UGV deviated from the planned path, command generation module 128 can activate path planning module 130 to generate an updated or enhanced path to be followed.

Command generation module 128 can comprise command effect computation module 136, for determining a predicted state of the UGV, given an initial state of the UGV and a navigation command to be executed by the UGV. The predicted state is the state the UGV is predicted to assume after execution of the navigation command, for example once the navigation command has been executed, at a predetermined time after the navigation command has been executed, when a following command is to be executed, or the like.

Command generation module 128 can comprise command storage/retrieval module 140 for storing and retrieving commands, which may be used in generating further commands as detailed below. The commands may be stored in and retrieved from any volatile or persistent storage device, such as storage device 112.

Command generation module 128 can comprise command providing module 144 for providing the newly generated command to vehicle control sub-systems 108, storing the command in storage device 112, or the like.

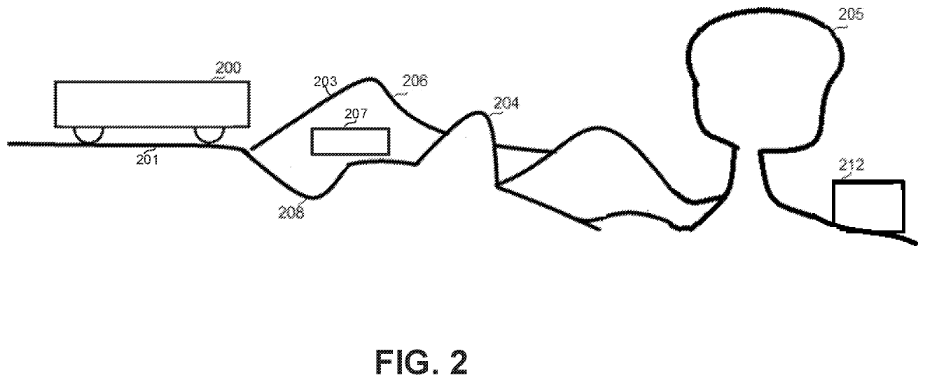

Reference is now made to FIG. 2, showing a schematic illustration of an example of an environment in which UGV 200 has to navigate from a current location to target location 212. The environment may comprise obstacles such as positive obstacle 204, which is above ground level, negative obstacle 208 which is below ground level, overhead obstacle 205 such as a tree or a bridge, ground level obstacle 207, inclined terrain 203 or 206 or steep terrain 204 which may be for example a back, side or front slope. All these obstacles are non-traversable for UGV 200 and have to be avoided. It will be appreciated that some objects present an obstacle when accessed from one side, but not when accessed from another side. For example, a ramp may present an obstacle when accessed from the side, but not when accessed from the front or rear.

Reference is now made to FIG. 3A, showing a flowchart of a method for navigating a UGV, in accordance with certain examples of the presently disclosed subject matter, and to FIG. 3B illustrating a sequence of commands generated for the UGV.

According to some examples, operations described with reference to FIG. 3A can be executed by elements shown in FIG. 1, including processor 122 and are thus described below with reference to the appropriate elements of FIG. 1, however this is done by way of example only and should not be construed as limiting.

With respect to the example of FIG. 3B, at time T₄ a command 366 is being generated, wherein the last command that has been executed is command 350 provided at time to, while commands 354, 358 (which may represent multiple commands—but they are multiple commands) and 362, generated at times T₁, T₂ and T₃, respectively, are pending, i.e., are expected to be executed. It will be appreciated that the number of non-executed commands pending at time T₄ may depend on the ratio between the delay time of a command and the command generation rate. For example, if the delay time of a command is 300 msec and a new command is generated every 100 msec, then there may be three pending commands to be considered when each new command is being generated.

In some embodiments, the pending commands may be arranged in a computer memory as a queue, such that the commands are retrieved from the memory for execution in the same order in which they are generated and stored, a scheme referred to as first-in-first-out (FIFO). When a command arrives to the head of the queue, it is retrieved from the queue and executed. Thus, at any given time, the queue may contain the pending commands awaiting execution. In the example of FIG. 3B, command 350 is the last command that has been retrieved from the queue, commands 354, 358 and 362 are in the queue and will be retrieved and executed in this order, and once command 366 is generated it will be entered into the queue as well, and will be retrieved for execution after commands 354, 358 and 362.

At block 300, a trigger event indication, indicating that an event that triggers generation of a new navigation command has occurred, 366, may be received. A trigger for generating navigation command 366 can be for example a timer interrupt where a new navigation command is generated in coordination with time e.g. at least every predetermined time period. In some examples, generation of a new navigation command is triggered at intervals of 50-1000 msec. Other trigger events may be the arrival to a predetermined location such as an end of a segment of the path, deviation of more than a predetermined distance from a followed path, detection of an obstacle at a distance shorter than a certain threshold, or the like. It will be appreciated that these examples are not exhaustive and various other triggers may likewise initiate the generation of a new command.

At block 302, the current state of the UGV is determined (for example by command generation module 128). The UGV state can be received, for example, by combining a previously known state and information received from INS 110 indicating changes in the vehicle parameters.

At block 304, it is determined, (e.g. by command storage/retrieval module 132) whether there exist pending navigation commands, i.e., navigation commands that have been previously generated but have not yet been executed, as a result of the command execution delay, and thus have not yet affected the state of the UGV. In the example of FIG. 3B, commands 354, 358 and 352 have not yet been executed, and are thus pending.

Each pending command that has not been considered, starting with the earliest pending command such as command 354 in the example of FIG. 3B, is retrieved (block 308). At block 312, the effect of executing the command on the state of the UGV is estimated. Estimation of the command effect may take into account the command itself, e.g. its duration, direction, amplitude, or the like, as well as steering characteristics of the UGV. According to some examples, pending commands are retrieved from storage device 112 by command storage/retrieval module 132.

The estimated effect of executing the pending command on the state of the UGV is determined (e.g. by effect computation module 136) to thereby obtain a predicted state of the UGV following execution of the pending command.

Operations described with reference to blocks 304, 308 and 312 are repeated for each pending command according to the order in which the commands were issued. Thus, after command 354 is processed, the earliest non-executed command that has not yet been considered is command 358 (or the earliest of the commands represented by command 358 if command 358 represents multiple commands), which is followed by command 362, and the effect of each of command(s) 358 and 362 on the state of the UGV is determined. It will be appreciated that for each additional command, the “future UGV state” that was determined with respect to the previous pending command (block 312) serves as the starting state for calculating the effect of the additional command.

When the earliest pending command, e.g., command 354 is processed according to block 312, the starting state of the UGV is its measured current state (as described with reference to block 302), while for each additional command processed according to block 312, the resulting UGV state that was determined with respect to the previous pending command (block 312) serves as the starting state for calculating the effect of the additional command.

Once the accumulative effect of all pending commands is determined and the estimated UGV state following execution of all pending commands (the starting state) is determined, at block 316 a new command 366 is generated. The command generation can be performed for example, by new command generation module 140. The command can be determined for directing the UGV along a path leading from the location related to the starting state to a destination location of the UGV as indicated by destination receiving module 124.

It will be appreciated that according to this example, since the command execution delay may be longer than the time difference between two consecutive trigger events, multiple trigger events may be received during the delay period. In FIG. 3B, if for example command 358 represents a single command, then during the delay between the generation and execution of command 366, commands 354, 358 and 362 will be executed. Therefore, the effect of executing each navigation command can be determined as part of generating multiple new commands, until the navigation command itself is executed. In the example of FIG. 3B, the effect of command 354 is determined during generation of commands 358, 362 and 366. In order to enhance efficiency, the starting state of each command and its respective effect can be stored. During the determination of further commands, if one of the pending commands has the same starting state as the stored state, the effect of the command and of all later commands will be the same and can thus be retrieved from the computer storage rather than re-calculated, thereby saving time and computation resources.

In some situations, for example if the UGV state estimated following a command deviates significantly, e.g. is beyond a predefined threshold from the planned path that is being followed, then a new path may be planned at block 320, for example by path planning module 130. The new path is planned to lead from the estimated location of the UGV to the destination. The new command can then be generated to cause the UGV to advance along the new path, or to take another action, for example reduce the UGV velocity, if the response of the UGV is not as expected, or a mistake was introduced, for example in planning a previous command.

Reference is made now also to FIGS. 4A-4C, demonstrating the provision of navigation commands in accordance with the disclosure.

FIG. 4A shows the UGV at time T₀ at position 404, with a velocity in the direction of vector V going from point 404 to point 408, and a destination location 424. Without considering delays and pending commands that have not been executed yet, a command that will drive the UGV along arc 410 to point 424 may be planned. However, due to the UGV state and velocity, the command is executed at time T₀+2DT, after the 2DT command execution delay. At T₀+2DT the UGV assumes position 408. Performing the generated command at time T₀+2DT will cause the UGV to hit obstacle 400, and miss the destination.

FIG. 4B shows the UGV at time T₀ at the same position 404 and velocity V as in FIG. 4A. In this situation, a command execution delay of 2DT length is taken into account, and the location at which the UGV is expected to be at time T₀+2DT is estimated as point 408. However, at time T₀+DT a previous command is executed, which has an effect such that at time T₀+2DT the UGV actually assumes position 416. Performing the command as planned at time T₀+2DT would therefore cause the UGV to assume position 420, which diverts it from destination 424.

FIG. 4C shows the UGV at time T₀ at the same position 404 and velocity V as in FIG. 4A. In this situation, the command execution delay is taken into account, as well as the commands that are expected to be performed before the currently planned command. Thus, the effect of a previously planned command starting at time T₀+DT will be determined, which is expected to cause the UGV to arrive to location 416 at time T₀+2DT. Then a command may be planned to bring the UGV to location 424 at time T₀+3DT. Thus, considering the provided commands, a newly generated command starts where it is supposed to start, and thus has the expected effect. This will provide for following the path as planned and arriving at the destination, without hitting obstacles.

Reference is now made back to FIG. 3. At block 324, once new command 366 is generated, it may be provided to vehicle control sub-systems 108, and the UGV is steered accordingly after all preceding commands are executed.

At block 328, the command may also be provided to command storage/retrieval module 132 which can store it in a storage device such as storage device 112. Storing the command will provide for estimating its effect when future commands are to be planned, as described above.

In some examples of the disclosure, the state of the UGV as estimated to be following execution of one or more commands, can be stored. Once the command has been performed, the actual state can be obtained and compared to the expected state. The comparison results of the pairs of corresponding expected and actual states can then be determined and used for updating and improving the expected states obtained on block 312. For example, if a substantially constant difference is determined, the difference can be added to (or subtracted from, depending on what state is subtracted from the other) the expected state. If the difference follows another pattern or function, this pattern or function can be applied to the expected state, thus providing for generating commands that indeed start at the expected state and cause the expected effect.

It is noted that the teachings of the presently disclosed subject matter are not bound by the components described in FIG. 1, and to the blocks described on FIG. 3. Equivalent and/or modified functionality can be consolidated or divided in another manner and can be implemented in any appropriate order or combination of software, firmware and hardware and executed on a suitable device.

Those skilled in the art will readily appreciate that various modifications and changes can be applied to the examples of the invention as hereinbefore described without departing from its scope, defined in and by the appended claims.

Examples of the presently disclosed subject matter are not described with reference to any particular programming language. It will be appreciated that a variety of programming languages can be used to implement the teachings of the presently disclosed subject matter as described herein.

1-40. (canceled)

41. A method of navigating an unmanned ground vehicle (UGV), the UGV including at least one processor, wherein the UGV exhibits a delay in execution of navigation commands generated for navigating the UGV, the method comprising:
before generating a new navigation command, estimating, by the at least one processor, an expected state of the UGV when the new navigation command is to be executed, wherein the expected state is estimated based on accumulated effects of execution of one or more pending commands preceding the new navigation command and which are ready to be executed during a delay in execution of the new navigation command;
generating, by the at least one processor, the new navigation command based on the expected state; and
following execution of pending commands, executing the new navigation command, for steering the UGV.

42. The method of claim 41, wherein estimating the expected state of a UGV comprises:
while there is at least one pending navigation command which has not been processed since an indication of a need to generate the new navigation command has been received:
retrieving by the processor an earliest pending navigation command which has not been processed since the indication has been received; and
determining, by the processor, an expected effect of the earliest pending navigation command on the state of the UGV; and updating the expected state of the UGV according to the expected effect.

43. The method of claim 41, further comprising steering the UGV in accordance with the new navigation command.

44. The method of claim 41, wherein generating the new navigation command for navigating the UGV comprises planning a path from a current location of the UGV to a destination of the UGV.

45. The method of claim 41, wherein the at least one pending navigation command comprises a number of commands, the number is determined in accordance with a command generation rate and time of the delay.

46. The method of claim 41, wherein the UGV further comprises an Inertial Navigation System (INS) operatively connected to a processor, the method further comprising:
receiving INS data indicative of a location of the UGV relative to a previous location; and
using the INS data in determining the state of the UGV to be used in obtaining the expected state of the UGV.

47. The method of claim 41, further comprising:
following execution of the one or more pending commands, comparing an actual state of the UGV to the expected state of the UGV, to obtain comparison results; and
updating the new navigation command based on the comparison results.

48. The method of claim 41, further comprising:
following execution of the one or more pending commands, comparing an actual state of the UGV to the expected state of the UGV, to thereby obtain comparison results; and
improving estimation of the expected state based on the comparison results.

49. The method of claim 48, further comprising updating the new navigation command based on the comparison results.

50. A system mountable on an unmanned ground vehicle (UGV), wherein the UGV exhibits a delay in execution of navigation commands generated for navigating the UGV, the system comprising:
a processor configured to:
before generating a new navigation command, estimate an expected state of the UGV when the new navigation command is to be executed, wherein the expected state is estimated based on accumulated effects caused by execution of one or more pending commands preceding the new navigation command and which are ready to be executed during a delay in execution of the new navigation command;
generate, by the processor, the new navigation command based on the expected state; and
following execution of pending commands, execute the new navigation command, thereby steering the UGV.

51. The system of claim 50, wherein the processor is configured for estimating the expected state of the UGV to:
while there is at least one pending navigation command which has not been processed since an indication that generation of the new navigation command is needed has been received:
retrieve by the processor an earliest pending navigation command which has not been processed since the indication has been received; and
determine an expected effect of the earliest pending navigation command on the state of the UGV to update the expected state of the UGV.

52. The system of claim 50, wherein the expected state of the UGV includes at least a location of the UGV.

53. The system of claim 50, is configured to generate steering commands for steering the UGV in accordance with the new navigation command.

54. The system of claim 50, wherein the at least one pending navigation command comprises a number of commands, and wherein the number of commands is determined in accordance with a command generation rate and a time of the delay.

55. The system of claim 50, wherein the processor is further configured to:
compare a current state of the UGV with a state predicted in association with generating a previous command to obtain comparison results; and
adapt the new navigation command in accordance with the comparison results.

56. The system of claim 51, wherein the indication is received responsive to an event selected from a group comprising a timer; and arrival of the UGV to a predetermined location.

57. The system of claim 50, wherein the processor is further configured to:
receive Inertial Navigation System (INS) data indicative of a location of the UGV relative to a previous location from an Inertial Navigation System (INS) operatively connected to a processor; and
use the INS data in determining the state of the UGV to be used in obtaining the expected state of the UGV.

58. The system of claim 50 wherein the processor is further configured to:
store an expected state of the UGV after execution of one or more commands;
upon execution of the one or more commands, compare an actual state of the UGV to the expected state of the UGV, respectively to obtain comparison results; and
update the new navigation command based on the comparison results.

59. An unmanned ground vehicle (UGV) that exhibits a delay in execution of navigation commands generated for navigating the UGV, the UGV comprises the system according to claim 58.

60. A computer program product including a computer readable storage medium retaining instructions, the instructions when read by a processor cause the processor to perform a method in an unmanned ground vehicle (UGV) that exhibits a delay in execution of navigation commands generated for navigating the UGV, the method comprising:
before generating a new navigation command, estimating, by the processor, an expected state of the UGV when the new navigation command is to be executed, wherein the expected state is estimated based on accumulated effects of execution of one or more pending commands preceding the new navigation command ready to be executed during a delay in execution of the new navigation command;
generating, by the processor, the new navigation command based on the expected state; and
following execution of pending commands, executing the new navigation command, thereby steering the UGV.
